(19) United States
(12) Patent Application Publication
(10) Pub. No.: US 2026/0170248 A1
(43) Pub. Date: Jun. 18, 2026

(54) COOPERATIVE NETWORK FOR SEMANTIC COMMUNICATION

(71) Applicant: Ohio State Innovation Foundation, Columbus, OH (US)

(72) Inventors: Enes Arda, Columbus, OH (US); Emrecan Kutay, Columbus, OH (US); Aylin Yener, Columbus, OH (US)

(21) Appl. No.: 19/416,892

(22) Filed: Dec. 11, 2025

Related U.S. Application Data
(60) Provisional application No. 63/734,481, filed on Dec. 16, 2024.

(51) Int. Cl. G06F 40/284; G06F 40/30; H04B 7/15

(52) U.S. Cl. CPC G06F 40/284; G06F 40/30; H04B 7/15

(57) ABSTRACT

An exemplary cooperative semantic communication system includes a relay node to obtain received source signals, from a source node, that include encoded embeddings of tokens, obtained by tokenizing a text message at the source node, broadcast to the relay node and a destination node. The relay node processes the received source signals to generate relay signals to transmit to the destination node to facilitate recovery of the tokens at the destination node. An exemplary cooperative semantic communication system includes a destination node to obtain received source signals from a source node and received relay signals from a relay node, implement channel decoding on each of the received source signals to obtain a first result, and implement channel decoding on each of the received relay signals to obtain a second result. The destination node obtains a token of a text message from the first result and the second result.

### CROSS-REFERENCE TO RELATED APPLICATIONS

This application claims priority under 35 U.S.C. § 119 (e) to Provisional Patent Application No. 63/734,481, filed Dec. 16, 2024, the entire contents of which are incorporated herein by reference.

### BACKGROUND

Wireless communication systems are becoming ubiquitous, and the volume and types of data being communicated are increasing. Conventional communication systems entail the transmission of digital sequences corresponding to data that facilitate receiving and recovering the data itself, without consideration of its meaning. To meet the demands of higher volumes of data transmission, as well as the strict latency requirements of emerging communication applications (e.g., digital twins, fully autonomous vehicles), semantic communication has become a developing approach. Semantic communication focuses on the meaning rather than the exact bits of the data.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for cooperative networks for semantic communication. An example cooperative semantic communication system includes a relay node to obtain received source signals from a source node. The received source signals include encoded embeddings of tokens, obtained by tokenizing a text message at the source node, broadcast to the relay node and a destination node. The relay node may process the received source signals to generate relay signals, and transmit the relay signals to the destination node to facilitate recovery of the tokens at the destination node.

In some aspects, the relay node processes each of the received source signals by implementing channel decoding to obtain a decoded embedding of a token and semantic decoding to obtain a decoded token. The relay node may implement the semantic decoding using a semantic state of the relay node, and the semantic state of the relay node may be updated to include the decoded token obtained through the channel decoding and the semantic decoding of each of the received source signals. The relay node may generate each of the relay signals by implementing semantic encoding and channel encoding on the decoded token obtained by processing each of the received source signals.

In some aspects, the received source signals include an embedding of a classification [CLS] token, which represents the text message in full, and the relay node generates each of the relay signals based on a respective one of the received source signals by implementing semantic encoding and channel encoding on a prediction of a token associated with a next one of the received source signals that follows the one of the received source signals. The relay node may process each of the received source signals to obtain the prediction of the token associated with the next one of the received source signals by implementing channel decoding of the respective one of the received source signals and semantic decoding using a semantic state of the relay node. The semantic state of the relay node may be updated based on a result of the channel decoding and the semantic decoding. The relay node may obtain received source signals including the encoded embeddings of all but a last one of the tokens.

An example cooperative semantic communication system includes a destination node to obtain received source signals from a source node and received relay signals from a relay node, implement channel decoding on each of the received source signals to obtain a first result, implement channel decoding on each of the received relay signals to obtain a second result, and implement semantic decoding on a concatenation of the first result and the second result to obtain a token of a text message. In some embodiments, the destination node implements the semantic decoding using a semantic state of the destination node, and the semantic state of the destination node is updated to include the output of semantic decoding.

An example method of performing cooperative semantic communication includes obtaining received source signals from a source node. The received source signals include encoded embeddings of tokens, obtained by tokenizing a text message at the source node, broadcast to the relay node and a destination node. The example method also includes processing the received source signals to generate relay signals, and transmitting the relay signals to the destination node to facilitate recovery of the tokens at the destination node.

In some aspects, the processing the received source signals to generate the relay signals includes implementing channel decoding to obtain a decoded embedding of a token and semantic decoding to obtain a decoded token. Implementing the semantic decoding includes using a semantic state of the relay node, and updating the semantic state of the relay node involves adding the decoded token obtained through the channel decoding and semantic decoding of each of the received source signals. In some aspects, the method includes the relay node generating each of the relay signals by implementing semantic encoding and channel encoding on the decoded token obtained by processing each of the received source signals.

In some aspects, the received source signals include an embedding of a classification [CLS] token, which represents the text message in full, and the method also includes the relay node generating each of the relay signals based on a respective one of the received source signals by implementing semantic encoding and channel encoding on a prediction of a token associated with a next one of the received source signals that follows the one of the received source signals.

The relay node processing each of the received source signals may include obtaining the prediction of the token associated with the next one of the received source signals by implementing channel decoding of the respective one of the received source signals and semantic decoding using a semantic state of the relay node. The method may include updating the semantic state of the relay node based on a result of the channel decoding and the semantic decoding. In some aspects, the relay node obtaining the received source signals includes the relay node receiving the encoded embeddings of all but a last one of the tokens.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. Repetition of labels for some components may be omitted for clarity of the illustrations.

FIG. 1 is a block diagram of an exemplary wireless cooperative semantic communication system according to various embodiments.

FIG. 2 indicates processes performed by components of the exemplary wireless cooperative semantic communication system of FIG. 1 according to some embodiments.

FIG. 3 indicates processes performed by components of the exemplary wireless cooperative semantic communication system of FIG. 1 according to other embodiments.

FIG. 4 is a block diagram of detailing aspects of processing circuitry that may be part of the source node, relay node, and destination node according to various embodiments.

### DETAILED DESCRIPTION

As previously noted, semantic communication is being developed to handle the increased use of wireless communication, as well as the need for lower latency communication. In semantic communication, the transmitter obtains semantic information, referred to as an embedding, from the data. This semantic information is encoded and transmitted. The transmitted signal is received and processed (e.g., decoded) at a receiver to recover the semantic information.

While semantic communication may increase the amount of information that can be communicated, the use of a relay node to amplify the transmitted signal may increase the reliability of the communication. A communication network that includes at least one relay between the transmitter and receiver may be referred to as a cooperative communication network. Obtaining a relayed source signal (from the relay), as well as obtaining the source signal (from the transmitter), may facilitate exact reconstruction of the source signal at the receiver. This, in turn, may increase the accuracy of the recovered semantic information obtained at the receiver.

In this context, wireless cooperative semantic communication networks and methods are described. According to various embodiments, a three-node cooperative network includes a source node (i.e., the initial transmitter), a relay node, and a destination node (i.e., the ultimate receiver). At the source node, a text message may be tokenized and operated on by a semantic encoder to obtain embeddings of the tokens. Token-by-token transmission signals may then be generated using a channel encoder.

According to some embodiments, the source node performs a token-by-token broadcast of each encoded signal. At the relay node, a channel decoder is used to obtain the embedding of each token and a semantic decoder is used to obtain a decoded token from each received signal. Each decoded token is used to update a semantic state of the relay node, and the semantic state is used in each subsequent semantic decoding process. The relay node may then re-encode each decoded token to generate and transmit a relay signal to the destination node. At the destination node, each pair of the received signal from the source node and the relay signal from the relay node may undergo channel decoding separately and may then be concatenated for semantic decoding to obtain each token. The destination node, like the relay node, may use semantic state, updated using each decoded token resulting from the channel decoding and the semantic decoding, for the subsequent semantic decoding.

According to some embodiments, the relay node predicts the next token to generate each relay signal rather than decoding and re-encoding the token. To facilitate the prediction of the first token, the source node may provide a classification ([CLS]) token, which represents the entire text message rather than one token of the tokenized text message. The source node may provide the [CLS] token to the relay node prior to broadcasting the encoded signal corresponding to the first token. In addition, the source node may transmit the last encoded signal (corresponding to the last token) only to the destination node, since the relay node need not make further predictions after the second-last encoded signal is received, enabling prediction of the last token.

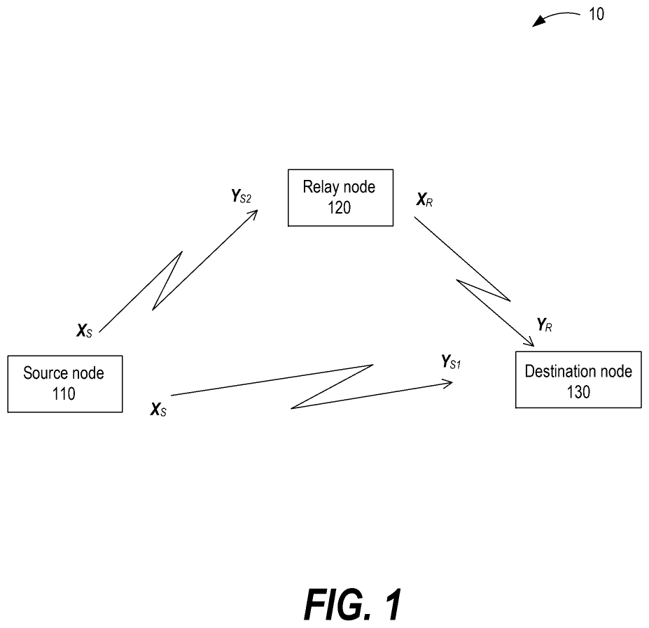

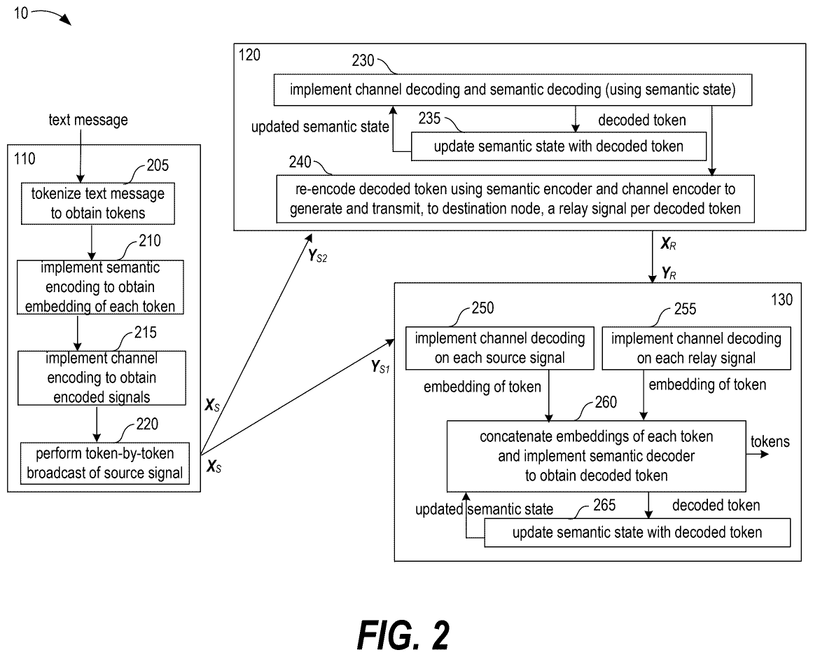

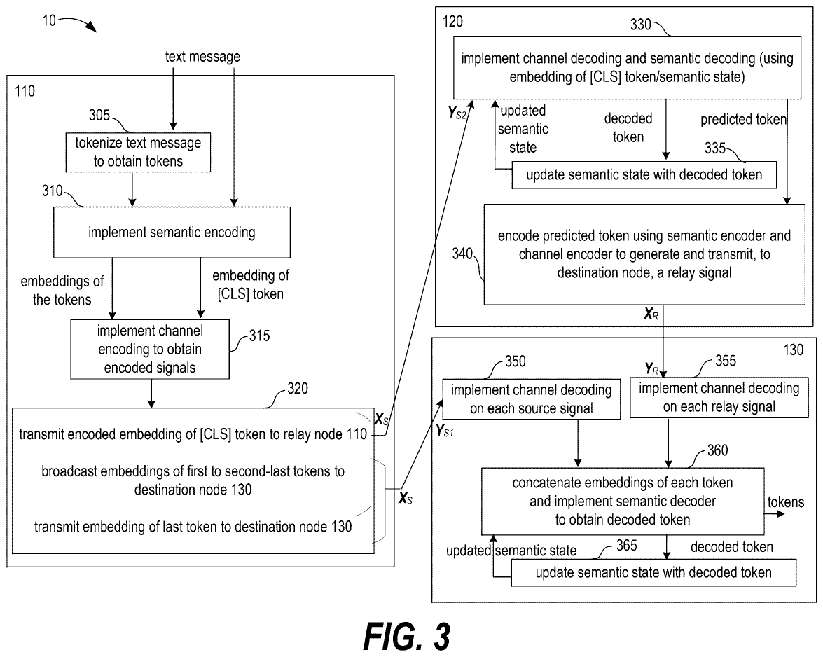

Turning to the drawings, FIG. 1 is a block diagram of an exemplary wireless cooperative semantic communication system 10 according to various embodiments. A source node 110, relay node 120, and destination node 130 are shown. The source node 110 may tokenize text messages to send semantically encoded tokens. As indicated, the source node 110 may transmit some or all encoded signals as source signals X_{S} to both the relay node 120 and the destination node 130. The relay node 120 processes the received source signals Yₛ₂ and transmits relay signals X_{R} to the destination node 130. The destination node 130 uses the received source signals Yₛ₁ and the received relay signals Y_{R} to recover the tokens of the text message. The processes implemented at the source node 110, relay node 120, and destination node 130 are further discussed for exemplary embodiments shown in FIGS. 2 and 3.

FIG. 2 indicates processes performed by components of the exemplary wireless cooperative semantic communication system 10 of FIG. 1 according to some embodiments. At the source node 110, a text message is tokenized (at 205) to obtain tokens, denoted as s={w¹, w², . . . , w^{T}}, with t indicating time index 1 to T. Given a maximum number of tokens L, T≤L. At 210, implementing semantic encoding to obtain an embedding of each token may entail using a pre-trained bidirectional encoder representations from transformers (BERT) model, for example. At 215, implementing channel encoding on the embeddings of the tokens to obtain encoded signals, referred to as source signals X_{S}, may be represented as follows:

$${X}_{S}^{t} = {Γ}_{S} ( {S}^{t} ( s ) ) \qquad [ EQ . 1 ]$$

In EQ. 1, Γ_{S} indicates the channel encoding operation, and S indicates the semantic encoding operation (e.g., implementation of the BERT model). The channel encoder may include a single fully connected (FC) neural network layer with an input embedding dimension ( [symbol] ) and an output dimension of 2 [symbol] . The value of [symbol] may be 384 and the value of 2 [symbol] may be 256, for example. The FC layer may be followed by normalization and a parametric rectified linear unit (PRELU) activation function. At 220, each token that undergoes semantic encoding (at 210) and channel encoding (at 215) to generate an encoded signal may be broadcast as one of the source signals X_{S}.

At the relay node 120, each encoded embedding of a token that is broadcast by the source node 110 as one of the source signals X_{S} is received as one of the received source signals Yₛ₂. At 230, implementing channel decoding and semantic decoding using semantic state may provide a decoded token. The operations to obtain a decoded token may be represented as:

$${\hat{w}}_{R}^{t} = {S}_{R}^{- 1} ( {Γ}_{R}^{- 1} ( {Y}_{S 2}^{t} ) , {𝕊}_{R}^{t} ) \qquad [ EQ . 2 ]$$

### In EQ. 2,

$${Γ}_{R}^{- 1} and {S}_{R}^{- 1}$$

represent the channel decoding and semantic decoding operations at the relay node 120, respectively. As indicated, the semantic state [symbol] of the relay node 120 is used in conjunction with the result of the channel decoder for semantic decoding.

The channel decoder, like the channel encoder employed at the source node 110 (at 215) may include a FC neural network layer with the input and output dimensions transposed from those of the channel encoder. That is, the FC layer of the channel decoder may have an input dimension of 2 [symbol] and an output dimension of [symbol] . The FC layer may be followed by normalization and a PRELU activation function, as in the channel encoder.

The semantic state [symbol] of the relay node 120 used in semantic decoding (at 230) may be comprised of previously decoded tokens up to the current index t. That is, as shown at 235, the semantic state [symbol] of the relay node 120 may be updated with each result of the channel decoding and the semantic decoding to be used in subsequent semantic decoding. In semantic decoding, the attention mechanism may facilitate dynamic focus of a model on relevant parts of the input to generate the (semantically decoded) output. The semantic state [symbol] of the relay node 120 may create a context through the attention mechanism to semantically decode each of the received source signals Yₛ₂. Because the semantic state [symbol] of the relay node 120 is comprised of previously decoded tokens, previous decoding results affect future decoding operations at the relay node 120.

Through the processes at 230 and based on the updated semantic state [symbol] of the relay node 120 at 235, the decoded tokens

$${\hat{s}}_{R}^{t} = \{ {\hat{w}}_{R}^{1} , {\hat{w}}_{R , ... ,}^{2} {\hat{w}}_{R}^{t} \}$$

are obtained at the relay node 120. At 240, each of the decoded tokens is re-encoded by a semantic encoder and channel encoder, similar to those used at the source node 110, for example, and transmitted as relay signals X_{R} to the destination node 130. Transmission from the relay node 120 to the destination node 130 may be via an orthogonal multiple access channel (MAC), for example.

At the destination node 130, received source signals Yₛ₁, resulting from the broadcast of the source signals X_{S} by the source node 110, and received relay signals Y_{R}, based on transmission of the relay signals X_{R} from the relay node 120, are obtained. As indicated, the received source signals Yₛ₁ and the received relay signals Y_{R} undergo separate channel decoding, since the signals reach the destination node 130 via different channels. At 250, the processes include implementing channel decoding on each of the received source signals Yₛ₁ to obtain an embedding of a token sent by the source node 110. At 255, the processes include implementing channel decoding on each received relay signal Y_{R} to obtain an embedding of a token sent by the relay node 120.

At 260, the embeddings of the same token obtained from the source node 110 (at 250) and from the relay node 120 (at 255) are concatenated and undergo semantic decoding. This is represented as:

$${\hat{w}}^{t} = {S}_{D}^{- 1} ( {Γ}_{D}^{- 1} ( {Y}_{S 1}^{t} , {Y}_{R}^{t} ) , {𝕊}_{D}^{t} ) \qquad [ EQ . 3 ]$$

### In EQ. 3,

$${Γ}_{D}^{- 1} and {S}_{D}^{- 1}$$

represent the channel decoding and semantic decoding operations at the destination node 130, respectively. As indicated, the semantic state [symbol] of the destination node 130 is used in conjunction with the result of the channel decoders (at 250 and 255) for semantic decoding.

The semantic state [symbol] of the destination node 130 used in semantic decoding (at 260) may be comprised of previously decoded tokens up to the current index t. That is, as shown at 265, the semantic state [symbol] of the destination node 130 may be updated with each decoded token to be used in subsequent semantic decoding. Based on the semantic decoding (at 260), the tokens generated (at 205) at the source node 110 may be recovered at the destination node 130.

FIG. 3 indicates processes performed by components of the exemplary wireless cooperative semantic communication system 10 of FIG. 1 according to some embodiments that differ from those discussed with reference to FIG. 2. At the source node 110, a text message is tokenized (at 305) to obtain tokens s={w¹, w², . . . , w^{T}}, as discussed with reference to 205 in FIG. 2. At 310 and 315, implementing semantic encoding and channel encoding involves similar processes to those described for 210 and 215 with reference to FIG. 2. According to the embodiments shown in FIG. 3, in addition to generating embeddings of the tokens obtained at 305, performing semantic encoding (at 310) also generates an embedding of a [CLS] token, denoted as S° (s). The embeddings of tokens and the embedding of the [CLS] token are all provided for channel encoding. That is, the processes at 310 and 315 may be represented by EQ. 1 with the [CLS] token additionally operated on by Γ_{S} and S.

The processes performed by the source node 110 at 320 differ in some ways from the processes performed by the source node 110 at 220 in FIG. 2. According to the embodiments discussed with reference to FIG. 2, the source node 110 broadcasts every encoded embedding of a token on a token-by-token basis as one of the source signals X_{S}. According to embodiments pertaining to FIG. 3, encoded embeddings of the first to second-last tokens may be broadcast, but the encoded embedding of the [CLS] token is only transmitted to the relay node 120, and the encoded embedding of the last token is only transmitted to the destination node 130. This is based on the fact that the relay node 120, according to some embodiments, predicts the next token rather than decoding and re-encoding tokens, as previously discussed with reference to FIG. 2.

The source node 110 may transmit the encoded embedding of the [CLS] token to the relay node 120 in a point-to-point (P2P) transmission, for example. As discussed with reference to the relay node 120, the relay node 120 may use the reconstructed embedding of the [CLS] token (reconstructed from one of the source signals X_{S}) to predict the first token. The source node 110 may transmit the encoded embedding of the last token to the destination node 130 in a P2P transmission, for example. This is because the relay node 120 will have completed predictions of all the tokens based on the broadcast of the encoded embedding of the second-last token.

At the relay node 120, the processes at 330 include implementing channel decoding and semantic decoding and are used to predict the next token based on each of the received source signals Yₛ₂. This differs from the processes at 230 shown in FIG. 2, which are used to obtain a decoded token according to EQ. 2. Semantic state [symbol] of the relay node 120, which is comprised of previously decoded tokens, may be used in the prediction, as indicated in EQ. 4 below. As shown in FIG. 3, the semantic state [symbol] of the relay node 120 may be updated (at 335) following implementation of a channel decoder and semantic decoder to obtain the decoded token (except the last token) broadcast in one of the source signals X_{S} by the source node 110.

The prediction of the next token by the relay node 120 may be represented as follows:

$${\hat{w}}_{R}^{t + 1} = {S}_{R}^{- 1} ( {Γ}_{R}^{- 1} ( {Y}_{S 2}^{t} ) , {𝕊}_{R}^{t} ) \qquad [ EQ . 4 ]$$

As shown in EQ. 4, the next token

$${\hat{w}}_{R}^{t + 1} ,$$

at time index t+1, is estimated using the received source signal

$${Y}_{S 2}^{t}$$

at the current time index t and the semantic state [symbol] of the relay node 120 at the current time index t. When the time index t is 0, the received source signal

$${Y}_{S 2}^{t}$$

includes the [CLS] token and EQ. 4 is used to estimate the first token (at time index t=1). At the relay node 120, at 340, each predicted token (at 330) is encoded by a semantic encoder and channel encoder to generate one of the relay signals X_{R} that is sent over an orthogonal multiple access channel (MAC) from the relay node 120 to the destination node 130.

The processes implemented at 340 are similar to those implemented at 240, as discussed with reference to FIG. 2, but predicted tokens (from 330) are processed at 340, rather than the decoded tokens (from 230) that are processed at 240. At the destination node 130, the processes at 350, 355, 360, and 365 are the same processes implemented at 250, 255, 260, and 265, as discussed with reference to FIG. 2.

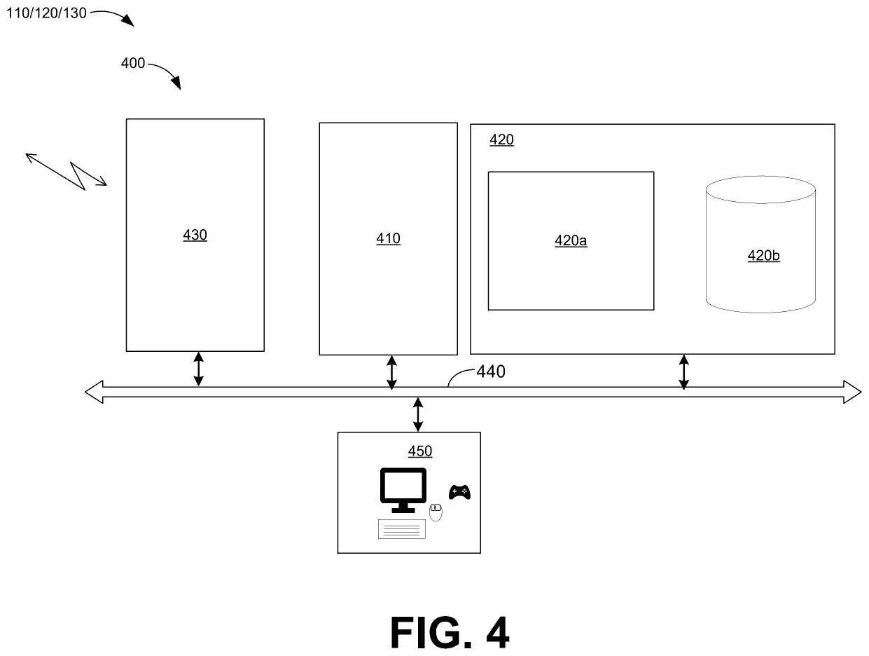

FIG. 4 is a block diagram detailing aspects of the source node 110, relay node 120, and destination node 130 according to various embodiments. The components shown in FIG. 4 may be referred to as processing circuitry 400, which facilitates the processes illustrated in FIGS. 2 and 3, for example. Aspects of the processing circuitry 400 may be implemented as a server or any other system providing computing capability or may employ a plurality of computing devices arranged, for example, in one or more server banks, computer banks, or other arrangements. In some cases, the processing circuitry 400 may correspond to an elastic computing resource where the allotted capacity of processing, network, storage, or other computing-related resources may vary over time.

The processing circuitry 400 may include one or more processors 410 and memory 420, including computer-readable media 420a to store instructions that are processed by one or more of the processors 410 and one or more databases 420b to store data. Computer-readable instructions should be understood as including software generated using programming languages such as, for example, C, C++, C#, Objective C, Java®, JavaScript®, Perl, PHP, Visual Basic®, Python®, Ruby, Flash®, or other programming languages. The processing circuitry 400 may also include communication components 430 (e.g., antennas) to facilitate wireless communication via the processing circuitry 400. Components of processing circuitry 400 may communicate via any known local interface 440 (e.g., a data bus with an accompanying address/control bus or other bus structure).

Any reference to processor 410 should be understood to mean one or more of the processors 410 (implemented sequentially or in parallel), and any reference to processor 410 should be understood to refer to the same, different, or a combination of the same and different processors 410 as other references to processor 410.

One or more processors 410 may comprise technologies that include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Memory 420 is defined herein as including both volatile and nonvolatile memory and data storage components. Volatile components are those that do not retain data values upon loss of power. Nonvolatile components are those that retain data upon a loss of power. Thus, the memory 420 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. In the context of the present disclosure, a computer-readable medium is a type of memory 420 and can be any medium that can contain, store, or maintain the logic or application described herein for use by or in connection with processing circuitry 400.

The processing circuitry 400 may additionally include user interface components 450 including one or more displays and input devices. The user interface components 450 may include, for example, one or more display devices such as liquid crystal display (LCD) displays, gas plasma-based flat panel displays, organic light emitting diode (OLED) displays, electrophoretic ink (E ink) displays, LCD projectors, or other types of display devices, etc. Input devices may include a keyboard, mouse, handheld console, etc.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

When relative terms such as “on,” “below,” “upper,” “lower,” “front,” “back,” and “rear” are used in the specification to describe the relative relationship of one component to another component, these terms are used in this specification for convenience only, for example, as a direction in relation to an orientation shown in the drawings. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is understood as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, the following is claimed:

1. A cooperative semantic communication system comprising:
a relay node configured to:
obtain received source signals from a source node, the received source signals including encoded embeddings of tokens, obtained by tokenizing a text message at the source node, broadcast to the relay node and a destination node;
process the received source signals to generate relay signals; and
transmit the relay signals to the destination node to facilitate recovery of the tokens at the destination node.

2. The cooperative semantic communication system according to claim 1, wherein the relay node is configured to process each of the received source signals by implementing channel decoding to obtain a decoded embedding of a token and semantic decoding to obtain a decoded token.

3. The cooperative semantic communication system according to claim 2, wherein
the relay node is configured to implement the semantic decoding using a semantic state of the relay node, and
the semantic state of the relay node is updated to include the decoded token obtained through the channel decoding and the semantic decoding of each of the received source signals.

4. The cooperative semantic communication system according to claim 3, wherein the relay node is configured to generate each of the relay signals by implementing semantic encoding and channel encoding on the decoded token obtained by processing each of the received source signals.

5. The cooperative semantic communication system according to claim 1,
wherein the received source signals include an embedding of a classification [CLS] token, which represents the text message in full, and
the relay node is configured to generate each of the relay signals based on a respective one of the received source signals by implementing semantic encoding and channel encoding on a prediction of a token associated with a next one of the received source signals that follows the one of the received source signals.

6. The cooperative semantic communication system according to claim 5, wherein the relay node is configured to process each of the received source signals to obtain the prediction of the token associated with the next one of the received source signals by implementing channel decoding of the respective one of the received source signals and semantic decoding using a semantic state of the relay node.

7. The cooperative semantic communication system according to claim 6, wherein the semantic state of the relay node is updated based on a result of the channel decoding and the semantic decoding.

8. The cooperative semantic communication system according to claim 5, wherein the relay node is configured to obtain received source signals including the encoded embeddings of all but a last one of the tokens.

9. A cooperative semantic communication system comprising:
a destination node configured to:
obtain received source signals from a source node and received relay signals from a relay node;
implement channel decoding on each of the received source signals to obtain a first result;
implement channel decoding on each of the received relay signals to obtain a second result; and
implement semantic decoding on a concatenation of the first result and the second result to obtain a token of a text message.

10. The cooperative semantic communication system according to claim 9, wherein
the destination node is configured to implement the semantic decoding using a semantic state of the destination node, and
the semantic state of the destination node is updated to include the output of the semantic decoding.

11. A method of performing cooperative semantic communication, the method comprising a relay node:
obtaining received source signals from a source node, the received source signals including encoded embeddings of tokens, obtained by tokenizing a text message at the source node, broadcast to the relay node and a destination node;
processing the received source signals to generate relay signals; and
transmitting the relay signals to the destination node to facilitate recovery of the tokens at the destination node.

12. The method according to claim 11, wherein the processing the received source signals to generate the relay signals includes implementing channel decoding to obtain a decoded embedding of a token and semantic decoding to obtain a decoded token.

13. The method according to claim 12, wherein
implementing the semantic decoding includes using a semantic state of the relay node, and
updating the semantic state of the relay node involves adding the decoded token obtained through the channel decoding and the semantic decoding of each of the received source signals.

14. The method according to claim 13, further comprising the relay node generating each of the relay signals by implementing semantic encoding and channel encoding on the decoded token obtained by processing each of the received source signals.

15. The method according to claim 11, wherein the received source signals include an embedding of a classification [CLS] token, which represents the text message in full, and the method further comprises:
the relay node generating each of the relay signals based on a respective one of the received source signals by implementing semantic encoding and channel encoding on a prediction of a token associated with a next one of the received source signals that follows the one of the received source signals.

16. The method according to claim 15, wherein the relay node processing each of the received source signals includes obtaining the prediction of the token associated with the next one of the received source signals by implementing channel decoding of the respective one of the received source signals and semantic decoding using a semantic state of the relay node.

17. The method according to claim 16, further comprising updating the semantic state of the relay node based on a result of the channel decoding and the semantic decoding.

18. The method according to claim 15, wherein the relay node obtaining the received source signals includes the relay node receiving the encoded embeddings of all but a last one of the tokens.
